(19) United States
(12) Patent Application Publication
(10) Pub. No.: US 2023/0354868 A1
(43) Pub. Date: Nov. 9, 2023

(54) DRIED GRAIN-LIKE GRANULES

(71) Applicant: NISSIN FOODS HOLDINGS CO., LTD., Osaka-shi, Osaka (JP)

(72) Inventors: Hiroshi KATAOKA, Osaka (JP); Kunihiko YOSHIDA, Osaka (JP); Yoshimi IWASAKI, Osaka (JP); Masashi KOMATSU, Osaka (JP)

(21) Appl. No.: 18/246,964

(22) PCT Filed: Dec. 21, 2021
(86) PCT No.: PCT/JP2021/047162

§ 371 Date: Mar. 28, 2023

(30) Foreign Application Priority Data
Mar. 26, 2021 (JP) 2021-053957

(51) Int. Cl. A23L 33/21; A23L 5/00; A23L 29/212; A23L 7/10

(52) U.S. Cl. CPC A23L 33/21; A23L 5/00; A23L 29/212; A23L 7/10

(57) ABSTRACT

An object of the present invention is to provide a dried grain-like granular product suppressing caloric intake, and having texture close to that of cooked rice. Another object of the present invention is to provide a dried grain-like granular product that can not only be used as a replacement of a part of cooked rice but can also be singly used. A dried grain-like granular product that can be eaten by cooking with heat, containing a resistant starch in a content of 20 to 80% by weight with respect to the entire amount, and a dried grain-like granular product further containing a non-resistant starch.

### TECHNICAL FIELD

The present invention relates to a dried grain-like granular product.

### BACKGROUND ART

In recent years, due to diverse lifestyles, products such as drinks, gummies, and 10 noodles designated as complete food and declaring that daily necessary nutrients can be simply taken have been placed on the market. Such a product contains essential nutrients in an amount of ⅓ or more of a daily necessary amount described in Nutrient Reference Values settled by the Japanese Ministry of Health, Labor, and Welfare, or in Dietary Reference Intakes for Japanese similarly formulated by the Japanese Ministry of Health, Labor, and 15 Welfare. Separately, there are semi-complete food that is lack of only several nutrients but is substantially complete food, and supplements for supplementing specific nutrients, and thus, a large number of food products with which nutrients necessary but deficient in a daily diet can be easily supplemented have been placed on the market.

The above-described foods are obtained by adding a new ingredient to ingredients 20 of original raw materials, and the component of the foods can be freely set. In addition, a method for altering the component is comparatively simple. For example, a drink can be obtained by adding a new ingredient to a liquid used as a solvent, and mixing the resultant. Alternatively, gummies or noodles may be obtained by adding a new ingredient to raw materials, and shaping the resultant through an ordinary production process. In this manner, 25 many of such foods have an aspect that a necessary ingredient can be comparatively easily added to the compound/an unnecessary ingredient can be comparatively easily removed from the compound.

On the other hand, rice, that is, Japanese staple food, can be freely altered in the composition. Owing to influence of recent health-consciousness, however, there is a 30 demand for rice reduced in caloric intake or rice having new nutrients added. To meet this demand, konjac rice obtained by shaping a mixture containing a konjac flour into a rice shape has been proposed (see Patent Literature 1). When the konjac rice is cooked as a replacement of a part of rice, elevation of glucose in blood is suppressed, and effects of suppressing caloric intake, although feeling of fullness can be obtained, and preventing obesity can be expected.

Besides, a method for cooking rice with resistant dextrin has been also proposed (see Patent Literature 2). When resistant dextrin is added, physiological effects such as suppression of blood glucose level elevation, regulation of intestinal function, and improvement of lipid metabolism can be expected.

### CITATION LIST

### Patent Literature

### Patent Literature 1: Japanese Translation of PCT International Application Publication No. 2020-505903

### Patent Literature 2: Japanese Patent No. 6125681

### SUMMARY OF INVENTION

### Technical Problem

In the case of Patent Literature 1, however, the texture of the konjac rice is soft differently from that of ordinary rice, and hence unnatural feeling is unavoidably caused in eating. On the other hand, in using a resistant material as in Patent Literature 2, it can be added before cooking rice in only an amount of about 10 to 15%, and when the amount is larger, there arises a problem of different texture/flavor from ordinary rice.

The present invention was devised in consideration of the above-described problems. Specifically, an object is to provide a dried grain-like granular product that suppresses caloric intake, and has texture and the like obtained by cooking with heat similar to those obtained by cooking ordinary rice. Besides, another object of the present invention is to provide a dried grain-like granular product that can not only be used as a replacement of a part of rice in cooking rice but can also be singly used.

### Solution to Problem

The present inventors examined whether or not the above-described problems can be solved even when a resistant starch is used. Then, it was newly found that caloric intake can be suppressed, and in addition, texture and the like similar to those of ordinary rice can be obtained by using a resistant starch and a non-resistant starch in combination, and thus, the present invention has been accomplished.

For solving the above-described problems, the present invention provides a dried grain-like granular product that can be eaten by cooking with heat, containing a resistant starch in an amount of 20 to 80% by weight with respect to the entire amount. Besides, it is more preferable that a non-resistant starch is further contained. Furthermore, it is preferable that a sugar and/or an amino acid is further contained, and is more preferable that the dried grain-like granular product has a calorie of less than 135 kcal per 100 g of the dried grain-like granular product after being cooked with heat.

### ADVANTAGEOUS EFFECTS OF INVENTION

Texture/flavor/clearness/gloss and the like, which can be easily lost in using a resistant starch, can be compensated, while caloric intake is reduced, by using a non-resistant starch.

Besides, although such a product is conventionally generally used as a replacement of a part of rice, the product of the present invention can be used as a replacement of the entire rice.

### DESCRIPTION OF EMBODIMENT

A preferable embodiment for practicing the present invention will now be described. It is noted that the embodiment described below is merely an example of a representative embodiment of the present invention, and does not allow the scope of the present invention to be narrowly interpreted.

A dried grain-like granular product according to the present invention is a product obtained by drying a kneaded material imitating the shape of grain. Here, grain refers to seeds of cereals that are seeds of gramineous crops such as rice, and may include pseudocereals such as buckwheat, amaranthus, and quinoa.

The dried grain-like granular product of the present invention contains a non-resistant starch and a resistant starch. Here, as the starch, various starches not especially limited, such as a tapioca starch, a potato starch, a corn starch, a waxy corn starch, a sweet potato starch, a wheat starch, and a rice starch, can be used. The amount of the non-resistant starch contained in the dried grain-like granular product of the present invention is preferably 30 to 75% by weight, and more preferably 40 to 50% by weight per 100 g of the dried grain-like granular product at a stage before cooking with heat.

Next, the resistant starch of the present invention means a starch resistant to amylase digestion, and examples include chemically modified processed starches such as a high amylose starch, a retrograded starch, a heat-moisture treated starch, one obtained by a strong crosslinking treatment with a crosslinking agent, and one obtained by ether substitution. Among these, a resistant starch obtained by a treatment with a crosslinking agent is preferably used in the present invention. Besides, the resistant starch used in the present invention has a calorie of preferably 0 to 2 kcal/g, more preferably 0 to 1 kcal/g, and further preferably 0 kcal/g. It is noted that the calorie is based on a value authorized by Japanese Association for Dietary Fiber Research.

As a raw material of the resistant starch, one, two or more selected from the group consisting of tapioca, wheat, potato, sweet potato, sago, high amylose corn, corn starch, waxy corn, rice, and pea can be used.

The amount of the resistant starch contained in the dried grain-like granular product of the present invention is preferably 25 to 70% by weight, and more preferably 50 to 60% by weight per 100 g of the dried grain-like granular product at the stage before cooking with heat. Besides, a compounding ratio between the resistant starch and the non-resistant starch is preferably 20:80 to 80:20.

It is said that cooked rice has a calorie of about 168 kcal/100 g. Therefore, for example, in using a resistant starch having a calorie of 0 kcal/g under conditions described in examples below, if 20% of rice is replaced with the resistant starch, the calorie is reduced by 28% to about 122 kcal, and if 60% of rice is replaced with the resistant starch, the calorie is reduced by 64% to about 61 kcal. Alternatively, in using a resistant starch having a calorie of 2 kcal/g under conditions described in the examples below, if 40% of rice is replaced with the resistant starch, the calorie is reduced by 28% to about 122 kcal, and if 60% of rice is replaced with the resistant starch, the calorie is reduced by 37% to about 106 kcal. In the present invention, the calorie is preferably less than 135 kcal.

In the dried grain-like granular product of the present invention, a sugar, a thickener, gluten, egg white, a colorant, another nutrient, and the like can be used as a sub material if necessary. Examples of a necessary nutrient include vitamin and calcium. Besides, such a sub material may be dissolved in water to be used.

In addition, in the present invention, a flavor oil and food additives, such as a sweetener, a colorant, a preservative, a thickening stabilizer, an antioxidant, a bittering agent, an acidulant, an emulsifier, an enhancement agent, and a flavor, may be added if necessary. In particular, from the viewpoints of imparting aroma in cooking rice, and masking a powdery texture of the resistant starch and bitterness of a nutrient, a flavor is preferably added. The flavor can be used in either form of a liquid and a powder, and is preferably added in kneading when in a powder form, and is preferably added in cooking rice or immediately before eating when in a liquid form.

Next, a method for producing a dried grain-like granular product will be described. In the present embodiment, a raw material can be prepared with an extruder. Specifically, a resistant starch, a non-resistant starch and water are kneaded with an extruder. The thus produced mixture is conveyed by a screw drive unit to be extruded through a die. The extrudate from the die is cut into a pellet shape, and thus, a grain-like granular product can be obtained. The extruder used in the present invention can be a single screw extruder, or a multiple screw extruder having two or more screws, and a twin screw type is preferably used from the viewpoint of quality stability. Any extruder including a raw material supply port, and a mechanism for conveying, in a barrel with a screw, mixing, compressing, and heating the raw material, and further a die attached to a barrel tip can be used.

In the present invention, it is suitable that a barrel temperature within the extruder is 80 to 140° C., and preferably 100 to 130° C. For compression of the present invention, it is suitable that a die portion pressure is 0 to 20 Bar, and preferably 0.5 to 10 Bar. Besides, grain-like granular products in various shapes can be obtained by changing the shape of the die. In the present invention, it is preferable that the extrudate is cut into an appropriate size with a rotary blade provided at the tip of the die. It is noted that the extrudate may be extruded like noodle strings and then cut into a desired size with a cutter or the like.

Finally, the thus obtained grain-like granular product is dried, and thus a dried grain-like granular product is obtained. A drying method is not especially limited, and examples include drying treatment methods such as a hot-air drying treatment, a vacuum-freeze-drying treatment, microwave drying, and air drying at a low temperature. These methods can be combined for the drying. In the present invention, the drying is performed preferably until a moisture content in the dried grain-like granular product becomes 15% or less.

### EXAMPLES

Now, the present invention will be described in more details based on examples. Here, an example using a high amylose rice-derived resistant starch as the resistant starch, and a high amylose rice-derived starch as the non-resistant starch will be described. Besides, commercially available rice (Koshihikari rice) was used as a reference example. Here, high amylose rice means rice having an amylose content of 25% or more, and is not especially limited in the breed of rice. Besides, a rice flour refers to a flour obtained by pulverizing high amylose rice into a powder form. It is noted that the size of the flour is not especially limited, and may be a grain size passable through an opening of 50 mesh (about 300 μm). On the other hand, a resistant starch refers to distarch phosphate of a high amylose rice-derived rice starch.

### Samples 1 to 7

First, a non-resistant starch and a resistant starch having a calorie of 0 kcal/g were mixed in each ratio shown in Table 1 below to a total amount of 10 kg. Next, a twin screw extruder was used for kneading the resultant with water added to obtain a 1:1 ratio between the flour and water. At this point, as setting conditions of the extruder, a barrel temperature was set to 100° C. to 130° C., and a screw speed (dough conveying speed) was set to 60 rpm. As the shape of a die of the extruder, a cylindrical shape of 2.0×6.5 mm was employed. Besides, the kneaded material extruded through the die was cut into a short rice size with a rotary blade provided at the tip of the die. Next, the extrudates having been cut were dried under a condition of 60° C. for 20 minutes. The resultant was stored for 60 minutes at ordinary temperature, and was then dried at 60° C. for 50 minutes, and thus, a dried grain-like granular product having a moisture content of 15% or less was obtained.

TABLE 1

| | Non-resistant Starch | Resistant Starch |
|---|---|---|
| Sample 1 | 0 | 100 |
| Sample 2 | 20 | 80 |
| Sample 3 | 40 | 60 |
| Sample 4 | 50 | 50 |
| Sample 5 | 60 | 40 |
| Sample 6 | 80 | 20 |
| Sample 7 | 100 | 0 |

### Samples 8 to 14

These samples were obtained in the same manner as the samples 1 to 7 except that a rice flour was used instead of the non-resistant starch. A compounding ratio between the rice flour and the resistant starch is shown in Table 2.

TABLE 2

| | Rice Flour | Resistant Starch |
|---|---|---|
| Sample 8 | 0 | 100 |
| Sample 9 | 20 | 80 |
| Sample 10 | 40 | 60 |
| Sample 11 | 50 | 50 |
| Sample 12 | 60 | 40 |
| Sample 13 | 80 | 20 |
| Sample 14 | 100 | 0 |

The samples 1 to 14 were cooked with a water addition ratio of 160%, and the reference example was cooked with a water addition ratio of 140%. A water addition ratio refers to a ratio of the weight of water to the weight of the dried grain-like granular product. For example, to “cook the sample 1 with a water addition ratio of 160%” means to cook it at a ratio of “100 g of the dried grain-like granular product of the sample 1 to 160 g of water”. In the reference example, it corresponds to a ratio of the weight of water to the weight of the commercially available rice. A calorie reduction ratio of each sample with respect to the reference example attained after cooking, and a state (texture/flavor/clearness/gloss) of grains as compared with that of the reference example after cooking were examined. It is noted that the grains after cooking were evaluated based on the following criteria. Results are shown in Table 3.

### (Criteria for Texture/Flavor)

⊚: comparable to the reference example
∘: slightly inferior to the reference example but sufficiently eatable
x: inferior to the reference example and unsuitable for eating

### (Criteria for Clearness/Gloss)

⊚: comparable to the reference example
∘: slightly inferior to the reference example but not blurry white and glossy
x: blurry white, and lack of gloss inherent in rice

TABLE 3

| | Calorie | | | | | |
|---|---|---|---|---|---|---|
| | Reduction | | | | | |
| | Ratio (%) | Quality | Texture | Flavor | Clearness | Gloss |
| Sample 1 | 100 | X | X | X | X | X |
| Sample 2 | 82 | ◯ | ◯ | ◯ | ◯ | ◯ |
| Sample 3 | 64 | ⊚ | ⊚ | ⊚ | ⊚ | ⊚ |
| Sample 4 | 55 | ⊚ | ⊚ | ⊚ | ⊚ | ⊚ |
| Sample 5 | 46 | ⊚ | ⊚ | ⊚ | ⊚ | ⊚ |
| Sample 6 | 28 | ⊚ | ⊚ | ⊚ | ⊚ | ⊚ |
| Sample 7 | 10 | ◯ | ◯ | ◯ | ◯ | ◯ |
| Sample 8 | 100 | X | X | X | X | X |
| Sample 9 | 82 | X | X | X | X | X |
| Sample 10 | 64 | ◯ | ◯ | ◯ | ◯ | ◯ |
| Sample 11 | 55 | ◯ | ◯ | ◯ | ◯ | ◯ |
| Sample 12 | 46 | ◯ | ◯ | ◯ | ◯ | ◯ |
| Sample 13 | 28 | ◯ | ◯ | ◯ | ◯ | ◯ |
| Sample 14 | 10 | ◯ | ◯ | ◯ | ◯ | ◯ |

It is understood from Table 3 that the quality/texture/flavor/clearness/gloss was improved as the ratio of the resistant starch is lower, and results comparable to that of the reference example were obtained in the samples 2 to 7. In particular, when the ratio of the resistant starch was 20 to 60%, favorable results were obtained in all the items. When the ratio of the resistant starch was 0% or 80%, the evaluation results were slightly inferior to that of the reference example but sufficiently eatable. On the other hand, a calorie reduction ratio is determined in accordance with the ratio of the resistant starch, and hence, it is understood that the amount of the resistant starch was reduced, the calorie reduction ratio was also lower.

On the contrary, it is understood that the samples 9 to 13 using the rice flour were poorly evaluated as compared with the samples 2 to 6. In particular, in the sample 9, the evaluation was lower than that of the sample 2 using a rice starch, that is, one ingredient of a rice flour. This suggests that the quality/texture/flavor/clearness/gloss is effectively improved when a rice starch is used as the resistant starch than when a rice flour is used.

### Samples 15 to 17

Subsequently, examination was made on a case of using a high amylose rice-derived resistant starch having a calorie of 2 kcal/g. These samples were the same as the samples 2, 4, and 6 except that the number of calories were different. The resultant samples 15 to 17 were cooked with a water addition ratio of 160%, and were evaluated based on the above-described criteria. Results are shown in Table 4.

TABLE 4

| | Calorie | | | | | |
|---|---|---|---|---|---|---|
| | Reduction | | | | | |
| | Ratio (%) | Quality | Texture | Flavor | Clearness | Gloss |
| Sample 15 | 46 | ◯ | ◯ | ◯ | ◯ | ◯ |
| Sample 16 | 32 | ⊚ | ⊚ | ⊚ | ⊚ | ⊚ |
| Sample 17 | 19 | ⊚ | ⊚ | ⊚ | ⊚ | ⊚ |

As shown in Table 4, also when the high amylose rice-derived resistant starch having a calorie of 2 kcal/g was used, results similar to those shown in Table 3 were obtained.

Next, regarding the non-resistant starch, a high amylose rice-derived starch and a normal amylose rice-derived starch were comparatively verified. Specifically, a dried grain-like granular product was produced by using a normal amylose-derived starch as the non-resistant starch of the sample 4. The thus obtained dried grain-like granular product was used as a sample 18, and was cooked with a water addition ratio of 160%. Then, the resultant was eaten to be compared with the sample 4 cooked similarly with a water addition ratio of 160%, and the reference example cooked with a water addition ratio of 140%. Results are shown in Table 5.

TABLE 5

| | |
|---|---|
| Sample 4 | Sample had good texture. Equivalent to Reference Example. |
| Sample 18 | Sample was inelastic, and had texture as if it was crushed. |

As shown in Table 5, when the high amylose rice-derived starch was used as the non-resistant starch (sample 4), the texture was good and equivalent to that of the reference example. On the contrary, when the normal amylose rice-derived starch was used, the resultant was inelastic, and had a texture as if it was crushed. In other words, it is presumed that the non-resistant starch makes contribution to reproduction of texture. Besides, as long as high amylose rice and normal amylose rice are compared, it is suggested that a high amylose rice-derived starch is suitable as the non-resistant starch.

Next, an effect obtained by further adding a monosaccharide, a disaccharide and/or an oligosaccharide was verified. Specifically, this verification example was the same as the sample 4 except that maltose and glucose were added respectively in amounts of 4% and 0.8% with respect to the entire weight of the starch. The resultant dried grain-like granular product was used as a sample 19, and was cooked with a water addition ratio of 160%. Then, the resultant was eaten to be compared with the sample 4 cooked similarly with a water addition ratio of 160%, and the reference example cooked with a water addition ratio of 140%. Results are shown in Table 6.

TABLE 6

| | |
|---|---|
| Sample 4 | Difficult to feel sweetness in chewing. |
| Sample 19 | Sweetness was felt in chewing. The degree of sweetness |
| | was equivalent to the reference example. |

As shown in Table 6, sweetness equivalent to that of the reference example was felt in chewing the sample 19 with the sugars compounded. On the contrary, sweetness was difficult to feel in chewing the sample 4 with no sugars compounded. Here, a resistant starch has a characteristic that sweetness is difficult to feel in chewing. This is because a starch is originally decomposed into maltose or glucose by chewing (amylase), but a resistant starch is difficult to decompose. Accordingly, it is suggested that a monosaccharide, a disaccharide and/or an oligosaccharide is preferably further compounded for obtaining a product closer to normal cooked rice.

Lastly, an effect of further compounding amino acids was verified. Specifically, this verification example was the same as the sample 4 except that amino acids were added in an amount of 0.006% with respect to the entire weight of the starch. The amino acids added here were aspartic acid, glutamic acid, alanine, glycine, and serine, which are regarded to be produced through an enzymatic reaction occurring in cooking commercially available rice such as Koshihikari rice. The resultant dried grain-like granular product was used as a sample 20, and was cooked with a water addition ratio of 160%. Then, the resultant was eaten to be compared with the sample 4 cooked similarly with a water addition ratio of 160%, and the reference example cooked with a water addition ratio of 140%. Results are shown in Table 7.

TABLE 7

| | |
|---|---|
| Sample 4 | Difficult to feel umami in eating. |
| Sample 20 | Umami was felt in eating. Equivalent to the reference |
| | example. |

As shown in Table 7, umami equivalent to that of the reference example was felt in eating the sample 20 with amino acids added. On the contrary, umami was difficult to feel in eating the sample 4 with no amino acids added. Accordingly, it is suggested that amino acids, particularly, aspartic acid, glutamic acid, alanine, glycine and serine, are preferably further compounded for obtaining a product closer to normal cooked rice.

As described so far, it has been revealed by the present invention that caloric intake can be suppressed, and in addition, texture and the like closer to those of normal rice can be obtained by using a resistant starch and a non-resistant starch in combination. Besides, it has been revealed that a product closer to normal cooked rice can be obtained when sugars and amino acids are used together.

1. A dried grain-like granular product that can be eaten by cooking with heat, comprising a resistant starch in a content of 20 to 80% by weight with respect to the entire amount.

2. The dried grain-like granular product according to claim 1, further comprising a non-resistant starch.

3. The dried grain-like granular product according to claim 2, further comprising a sugar and/or an amino acid.

4. The dried grain-like granular product according to claims 1, having a calorie of less than 135 kcal per 100 g of the dried grain-like granular product after being cooked with heat.

5. The dried grain-like granular product according to claim 2, having a calorie of less than 135 kcal per 100 g of the dried grain-like granular product after being cooked with heat.

6. The dried grain-like granular product according to claim 3, having a calorie of less than 135 kcal per 100 g of the dried grain-like granular product after being cooked with heat.
